(19) United States
(12) Patent Application Publication
(10) Pub. No.: US 2006/0236590 A1
(43) Pub. Date: Oct. 26, 2006

(54) Triggering apparatus for rotating-frame animal trap

(76) Inventor: Clarence E. Hootman, Farmington, IA (US)

Correspondence Address: SCHROEDER & SIEGFRIED, P.A., 15600 WAYZATA BOULEVARD, SUITE 200, WAYZATA, MN, 55391, US

(21) Appl. No.: 11/112,310

(22) Filed: Apr. 21, 2005

(51) Int. Cl. A01M 23/24

(52) U.S. Cl. 43/92

(57) ABSTRACT

A triggering apparatus for a rotating-frame animal trap including a collapsible enclosure capable of supporting the trap in set position in alignment with the enclosure entrance, the enclosure having a separate bait container mounted within its interior and a triggering lever extending within the bait container, whereupon movement of the lever within the bait container causes rotation of a release shaft that frees a catch holding the trap in set position, thereby firing the trap and pinning the animal within the trap's rotating jaws. The catch includes a detent that holds the jaws of the trap in set position against the body of the enclosure adjacent its entrance, such that the animal must pass through the set jaws of the trap in order to access the bait container. The bait container is constructed with a restricted opening of substantially smaller compass than the entrance of the enclosure so as to permit access only by a smaller animal's paw, and prevent such animals, as dogs, from triggering the trap with their snout.

### BACKGROUND OF THE INVENTION

The present invention relates generally to the field of animal traps, and more specifically to the art of triggering devices for use in connection with so-called “instant kill” animal traps of the rotating-frame type.

Many attempts have been made over the years to develop an animal trap that will effectively and humanely dispose of certain animals, such as raccoons, which continue to pester farmers and the like by destroying vegetation, poultry and other small animals. Since such animals are generally paw-feeders that use their paws to reach for and grasp their food, a number of spring-loaded “leg-hold” type trapping devices have been developed which are designed to clamp down on the leg of the animal upon triggering same. Devices of this type are disclosed in U.S. Pat. Nos. 6,658,787; 4,802,301; 4,483,093; and 4,158,929. These devices, while somewhat effective, are disadvantageous in that the trapped animal will oftentimes suffer a long and slow death, or self-mutilate its own extremities in an attempt to free itself.

The rotating-frame type animal trap, also commonly named the “Conibear” trap after its original inventor, is generally considered to be more effective and humane in that it is designed as an “instant kill” device. This trap is designed with a pair of metal rectangular frames or jaws that are cooperatively hinged midway and spring-loaded for rapid and forceful closure upon actuation. Upon actuation, the jaws are intended to snap shut on the animal's spinal column at the base of the skull, thus causing instant death.

Conventionally, as a means for triggering a rotating-frame trap, one jaw will carry a baited trigger that extends into the passageway created by the jaws, and the other jaw has a catch element that holds the trap open in its set position. However, with this conventional triggering device, it is impossible to control the size, species, or direction of the animal entering the trap. Since the trap is designed and intended to clamp down on the main body or torso of the animal, its passageway is large enough to accommodate the head and/or body of other larger animals that are also lured to the bait. Consequently, domestic animals and pets, such as dogs, are frequent victims of this type trap.

The indiscriminate nature of the above conventional triggering means has been a long-standing and continuing problem that persists to this day. In those areas where trapping is still prevalent, numerous veterinary reports are available showing continued findings of domestic animals and pets that have unwittingly found there way into the deathly grip of the jaws of such traps. It is with this in mind that I have come to conceive of and develop my improved triggering device for use in connection with such rotating-frame traps, which will become more apparent from the description to follow, particularly when read in conjunction with the accompanying drawings.

### BRIEF SUMMARY OF THE INVENTION

In accordance with the present invention, my improved triggering apparatus for a rotating-frame animal trap utilizes an enclosure separate from the trap that is capable of supporting the trap in set position with the passageway through the jaws of the trap positioned in general alignment with the entrance to the enclosure. Importantly, the conventional triggering device used in connection with such traps, which typically extends into the passageway of the trap, is removed so as not to obstruct the enclosure entryway.

Mounted within the interior of the enclosure is a separate bait container having an opening thereto which preferably faces the entryway to the enclosure. The opening-defining portions of the bait container are of substantially smaller compass than that of the enclosure entryway, having major dimensions suitable only for accommodating the relatively small arm of a raccoon, opossum or other like “paw-feeding” animal.

Mounted atop the enclosure is a catch mechanism that includes a detent member for engaging and holding the jaws of the rotating-frame trap in set position against the body of the enclosure. The detent member is pivotally mounted near the front of the enclosure and extends outwardly and downwardly therefrom toward the enclosure entryway, thereby defining a channel or space between it and the enclosure which is appropriately sized to accommodate and hold the jaws of the trap.

A detent actuating shaft is pivotally connected to the detent member and extends rearward therefrom toward a catch release mechanism. The detent actuating shaft is axially movable between a forward “closing” and a rearward “opening” detent position, and is positioned for releasable engagement by the catch release mechanism when the triggering apparatus is supporting the trap in its set position prior to actuation.

The catch release mechanism includes a release shaft rotatably mounted to the enclosure with a triggering lever extending radially outward therefrom and into the inner confines of the bait container. The release shaft extends upwardly toward and connects to a release catch or “dog” that may be set with variable sensitivity for releasable engagement of the catch mechanism that holds the trap in its set position. The release dog functions to hold a freely rotatable trigger gate stationary, which in turn releasably engages the detent shaft of the catch mechanism and holds the same in its “closed” detent position pending actuation of the triggering device.

To set the triggering device and rotating-frame trap, the trigger gate of the catch release mechanism may be set with the release dog at the desired sensitivity. The rotating-frame trap may also be set by any conventional means to its spring-loaded firing position. With the triggering device set, the pre-set rotating-frame trap, ready for actuation, may then be mounted on the enclosure adjacent its entryway with the jaws of the trap sandwiched between the enclosure body and detent member, and in proper alignment to permit passage therethrough.

The force of the trap jaws will then push against the detent member of the catch mechanism, causing the detent actuating shaft to bear firmly against the trigger gate in readily releasable relation.

Once set, actuation of the triggering device requires an animal to enter the enclosure through its entryway, and consequently through the passageway of the rotating-frame trap. Actuation of the triggering device and trap cannot occur, however, unless and until the animal is capable of reaching its arm through the restricted opening of the bait container, which is notably too small for the snout of a domestic animal, such as a dog. Upon reaching for the bait, the inquisitive “paw-feeding” animal will pull the trigger lever forward toward the opening of the bait container, thereby causing rotation of the release shaft. This, in turn, rotates the release dog, thus freeing the trigger gate which holds the detent actuating shaft and detent member in closed position. With the detent member free to rotate to an open position, the jaws of the trap are also free to rotate, and will rapidly and forcefully close upon the animal.

Preferably, as a means of convenience to facilitate storage, packaging and transportation of my new triggering device, the enclosure body may be configured from a plurality of exterior frame sections that are constructed to be collapsible. Although this may be accomplished by any known means, it is presently contemplated that selected frame sections may include snap-lock brackets designed for ease of dismantling and securing the same together to form the enclosure. With such construction, the triggering device may be readily broken down for ease of packaging and shipment, and can be readily transported and reconstructed in the field, when and where desired.

### BRIEF DESCRIPTION OF THE DRAWINGS

These and other objects and advantages of the invention will more fully appear from the following description, made in connection with the accompanying drawings, wherein like reference characters refer to the same or similar parts throughout the several views, and in which:

FIG. 1 is a perspective view of a triggering apparatus for a rotating-frame animal trap constructed in accordance with the principles of my invention, and shown in its set position;

FIG. 2 is a perspective view of the triggering apparatus for a rotating-frame animal trap shown in FIG. 1, shown in its set position with a rotating-frame animal trap mounted thereon in accordance with the principles of my invention;

FIG. 3 is a vertical sectional view taken along lines 3-3 of FIG. 2, showing a separate bait container mounted within the interior of the triggering apparatus, where the bait container is shown partially broken away to further illustrate the construction of the triggering apparatus;

FIG. 4 is a partial top plan view of the triggering apparatus shown in FIG. 1, showing the construction of the catch mechanism and catch release mechanism of the triggering apparatus;

FIG. 5 is a vertical sectional view, similar to that shown in FIG. 3, of a triggering apparatus constructed in accordance with the principles of my invention, showing the bait container partially broken away to illustrate the operation of the triggering apparatus upon actuation thereof, and

FIG. 6 is a partial top plan view of a triggering apparatus constructed in accordance with the principles of my invention, showing the operation of the catch mechanism and catch release mechanism of the triggering apparatus upon actuation thereof.

FIG. 7 is an exploded perspective view of the triggering apparatus showing the manner in which my invention may be broken down for ease of storage, packaging and transportation.

### DETAILED DESCRIPTION OF THE INVENTION

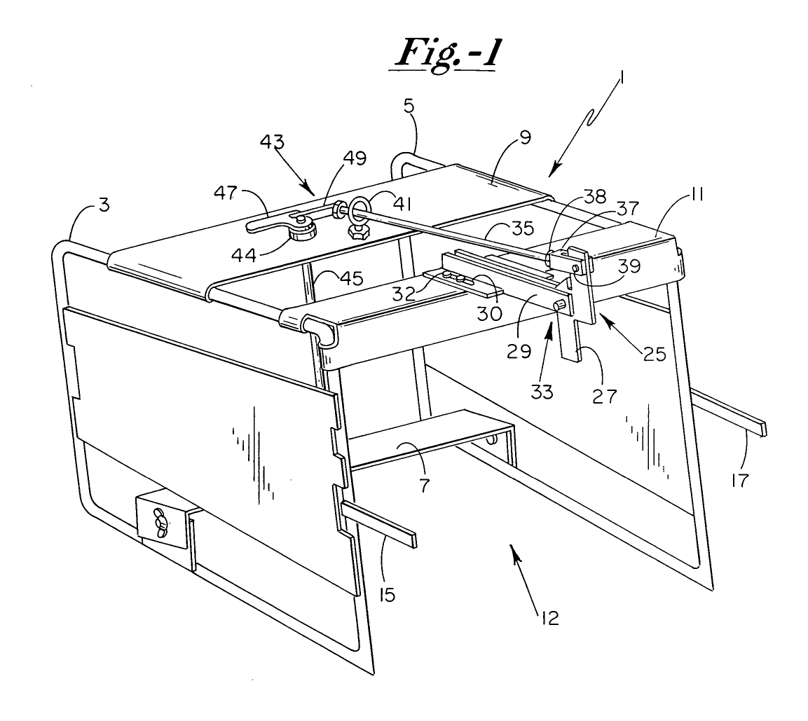

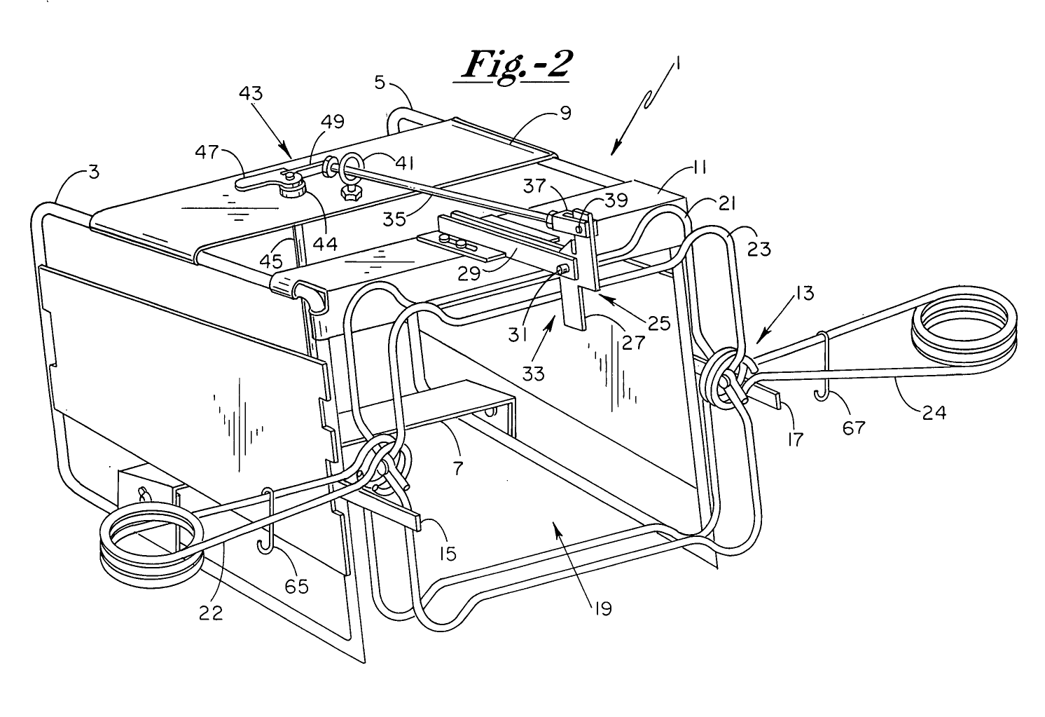

As shown in FIG. 1, and in accordance with the present invention, my improved triggering apparatus for a rotating-frame animal trap includes an outer enclosure 1 which is constructed of a pair of spaced side-body frame sections 3 and 5 that are interconnected by a lower transverse cross-panel 7 and upper transverse cross-panels 9 and 11 to define a front enclosure entryway 12. The enclosure 1 is constructed to be a stand-alone unit that is separate from the trap which it is meant to support. More specifically, as shown best in FIG. 2, the enclosure 1 includes supporting arms 15 and 17 which extend outward and forwardly from side-body frame sections 3 and 5, respectively, to support a rotating-frame animal trap 13 when the same is set in its spring-loaded firing position. When properly set, as shown in FIG. 2, the trap 13 is supported by its actuating springs 22 and 24 on the arms 15 and 17 with the passageway 19 through the trap jaws 21 and 23 positioned in general alignment with the entrance 12 to the enclosure. As will be apparent to those skilled in the art, the conventional triggering device used in connection with such rotating-frame type traps 13, which typically extends into the passageway of the trap, is removed so as not to obstruct the enclosure entryway 12.

Mounted atop enclosure 1 on cross-panels 9 and 11 is a catch mechanism 25 that includes a detent member 27 for engaging and holding the jaws 21 and 23 of the rotating-frame trap 13 in set position against the front cross-panel 11 of the enclosure 1. The detent member 27 is pivotally mounted via pivot pin 31 to an extension bracket 29 which is fixed to and extends outward and forward from the front cross-panel 11 of the enclosure 1. When the catch mechanism 25 is in set position, as shown in FIG. 2, the detent member 27 extends downwardly from the extension bracket 29 toward the enclosure entryway 12, and generally parallel to the front of the enclosure 1. This defines a channel or space 33 between detent member 27 and the front cross-panel 11 of the enclosure 1 which, as is discussed in more detail below, is appropriately sized to accommodate and hold the jaws 21 and 23 of the trap 13 when it is being supported by the triggering apparatus in its spring-loaded firing position.

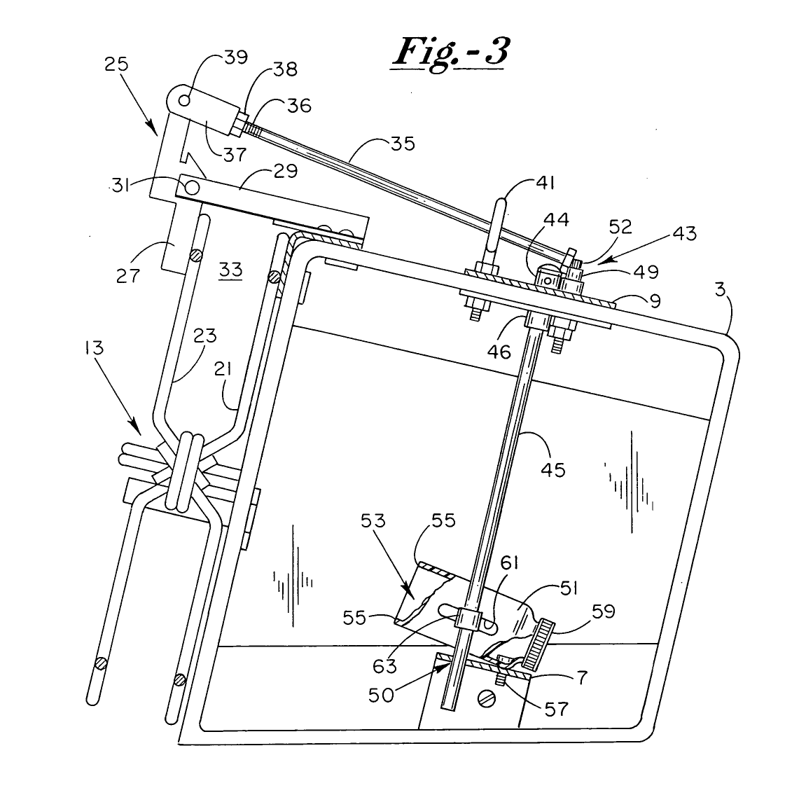

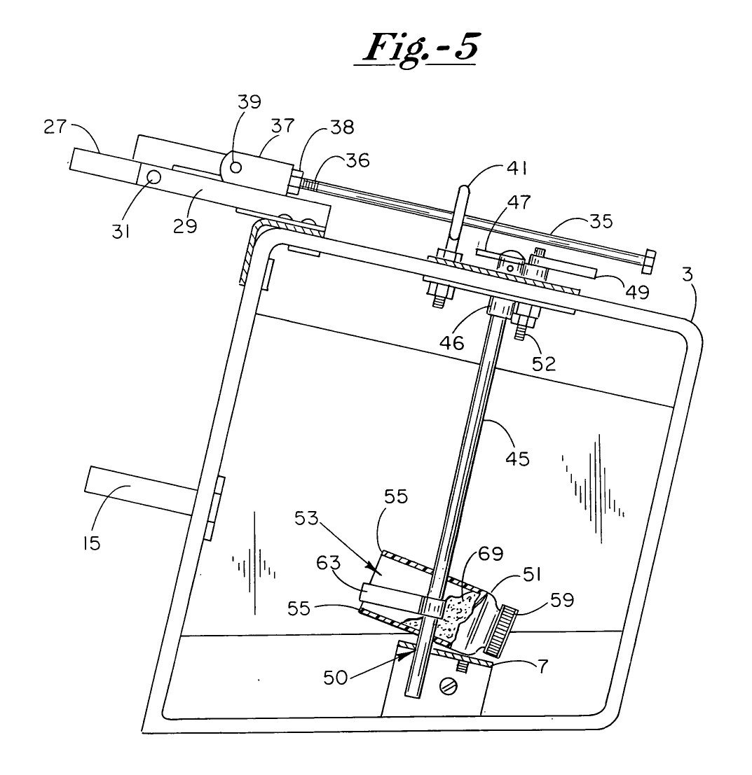

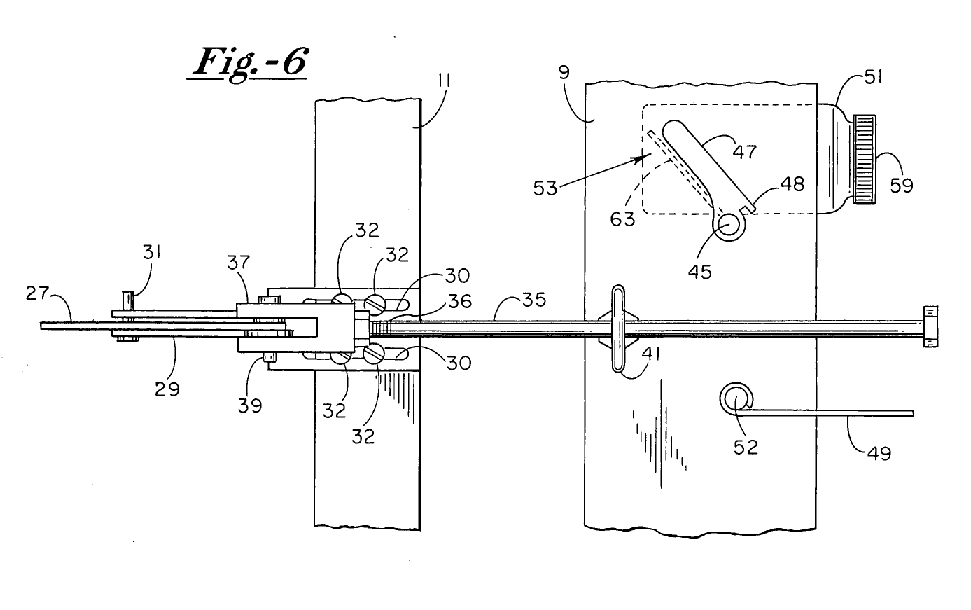

As shown further in FIG. 2, connected to the upper end of detent member 27 is an axially movable detent actuating shaft 35, which extends rearward therefrom through guide ring 41 toward a catch release mechanism 43. The shaft 35 is pivotally connected to detent member 27 via yoke member 37 and pivot pin 39 above the pivotal connection of the detent member 27 to extension bracket 29, so as to cause the detent member 27 to pivot about pin 31 when the detent actuating shaft is moved axially. Notably, as shown best in FIG. 3, detent member 27 is constructed such that the pivotal connection of shaft 35 thereto is positioned slightly forward relative to pivot point 31. This helps to ensure that the force imparted to shaft 35 through rotation of the detent member 27 upon release of the triggering apparatus 1 will be directed primarily axially along the shaft, thereby preventing the same from binding. The detent actuating shaft 35 is axially movable between a forward “closing” (FIGS. 1-4) and a rearward “opening” (FIGS. 5-6) detent position, and as shown in FIGS. 2 and 3, it is positioned for releasable engagement by the catch release mechanism 43 when trap 13 is supported by the triggering apparatus in its set position.

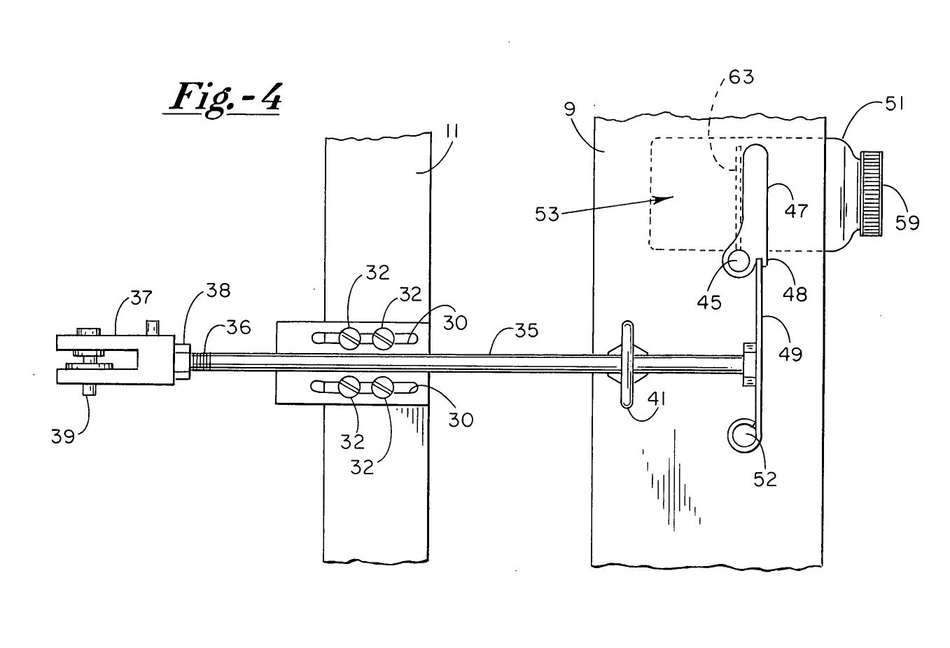

Due to differing design configurations of jaws 21 and 23 for certain makes of rotating frame traps, the distance between jaws 21 and 23 may vary. As best shown in FIG. 4, to accommodate for such variances and provide appropriate spacing to receive the jaws of trap 13, extension bracket 29 is preferably constructed to be adjustably mounted to cross-panel 11. As seen in FIG. 4, bracket 29 includes mounting slots 30 through which screws 32 extend to secure to cross-panel 11. By loosening screws 32, bracket 29 may be slid forward or rearward along cross-panel 11, thereby adjusting the width of channel 33 between the detent member 27 and cross-panel 11.

Of course, as bracket 29 is adjusted forward or rearward, the length of the detent actuating shaft 35 must also be correspondingly adjusted, as it is important to maintain the positioning of detent member 27 in substantially parallel relation to the front of enclosure 1 when supporting trap 13 in its set position. Failure to do so may cause inconsistency in the operation of triggering apparatus 1 and/or premature triggering of the trap 13. As shown best in FIGS. 3 and 4, in order to adjust the length of shaft 35, threaded end 36 of shaft 35 is threaded into yoke 37, and may be adjusted inward or outward relative thereto. Once adjusted to the appropriate length, locking nut 38 is provided to fixedly lock shaft 35 within yoke 37.

As shown best in FIGS. 2 and 4, the catch release mechanism 43 includes a release catch or “dog” 47 which is positioned atop of cross-panel 9 adjacent the rear end of detent actuating shaft 35. Release dog 47 is secured to a generally vertically extending release shaft 45 that is rotatably mounted between the lower and upper cross-panels 7 and 9 of enclosure 1. Shaft 45 extends through upper cross-panel 9, and lock collars 44 and 46 carried by shaft 45 above and below cross-panel 9 are used to rotatably mount shaft 45 thereto. The lower end of shaft 45 extends freely through opening 50 in lower cross-panel 7.

As shown best in FIG. 4, the release dog 47 includes a notched portion 48 which functions to hold a trigger gate 49 in set position, pending actuation of the triggering device. Trigger gate 49 is also rotatably mounted atop of cross-panel 9 via pin 52 adjacent the rear end of the detent actuating shaft 35, but on the opposite side relative to the release dog 47. Thus, the trigger gate 49, when in set position, extends across the rear end of the detent actuating shaft 35, and is engaged by release dog 47. In such position, the detent actuating shaft 35 bears against trigger gate 49 and releasably holds shaft 35 of the catch mechanism 25 in its “closed” detent position, pending actuation of the triggering device.

Notably, the release dog 47 may be set with variable sensitivity to adjust the desired force necessary for release of trigger gate 49 and catch mechanism 25 that holds the trap 13 in its set position. To adjust the sensitivity, release dog 47 may be rotated slightly to alter the degree of engagement between the notched portion 48 of dog 47 and the trigger gate 49, thereby increasing or decreasing the amount of necessary rotational movement of shaft 45, and consequently dog 47, to release trigger gate 49.

As seen in FIG. 3, mounted within the interior of the enclosure 1 is a separate bait container 51 having an opening 53 thereto which preferably faces the entryway 12 to the enclosure 1. The opening-defining portions 55 of the bait container 51 are of substantially smaller compass than that of the enclosure entryway 12, having major diametrical dimensions of preferably less than approximately three (3) inches, and in any event, suitable only for accommodating the relatively small arm of a raccoon, opossum or other like “paw-feeding” animal. The bait container 51 may be secured to the lower cross-panel 7 within enclosure 1 by any suitable means, such as screw 57, and is positioned immediately adjacent the rotatably mounted release shaft 45. Optionally, as shown in FIG. 3, container 51 may have a removable cap 59 at its rear end to help facilitate loading bait into the bait container when so desired.

The bait container 51 also includes a side slot 61 through which the free end of a triggering lever 63 extends. Preferably, triggering lever 63 extends within the confines of the bait container 51 substantially all the way across the opening 53, leaving only a small clearance between its free end and the sidewall of the container 51, so as to be disposed within the pathway leading from the opening 53 to the rear of the container where the bait is to be placed. As seen in FIGS. 3 and 4, the opposite end of the triggering lever 63 is secured by any suitable means, such as a lock collar, to the rotatable shaft 45 at a position immediately adjacent slot 61 in the bait container 51. Thus, as shown, lever 63 extends radially outward from rotatable shaft 45 and into the inner confines of the bait container 51. As shown best in FIG. 3, slot 61 is constructed of suitable length along an axis between the opening 53 and rear end of the bait container 51 so as to facilitate free swinging movement of the lever 63 within the confines of the bait container 51.

In operation, one using my improved triggering device will preferably first set the jaws 21 and 23 of the rotating-frame animal trap 13 to their spring-loaded firing position, utilizing the trap's spring locking clamps 65 and 67 in a conventional manner to hold the jaws in set position prior to loading the trap 13 onto the triggering device 1. With the trap 13 set, the triggering device 1 may then also be set to its triggering position, as shown in FIGS. 1-4, with the trigger gate 49 and release dog 47 adjusted to the desired release sensitivity. With the triggering apparatus set, the pre-set rotating-frame trap 13, ready for actuation, may then be mounted on the enclosure 1 in corresponding alignment with entryway 12 (as shown in FIG. 2). In such position, the trap's actuating springs 22 and 24 will rest on supporting brackets 15 and 17, and the jaws 21 and 23 thereof are inserted within the channel 33 created between the upper front cross-panel 11 of the enclosure 1 and the downwardly protruding detent member 27. Once position correctly, the spring locks 65 and 67 may be released, and the closing force of the trap jaws 21 and 23 will push against the enclosure 1 and detent member 27, causing the detent actuating shaft 35 to bear firmly against the trigger gate 49 in readily releasable relation, as shown in FIG. 2.

The operation of my improved triggering apparatus upon actuation is best described in reference to FIGS. 5 and 6, where the triggering apparatus is shown in it actuated or “fired” position. Once set, actuation of the triggering device requires an animal to enter the enclosure 1 through its entryway 12, and consequently through the passageway 19 of the rotating-frame trap 13. Actuation of the triggering device and trap cannot occur, however, unless and until the animal is capable of reaching its arm through the restricted opening 53 of the bait container 51, which is notably too small for the snout of a domestic animal, such as a dog.

Upon reaching for the bait, the inquisitive “paw-feeding” animal must push its paw past the trigger lever 63 to access the bait 69 which is located near the rear of the bait container 51. As shown in FIGS. 5 and 6, upon withdrawing its paw, the animal will pull the trigger lever 63 forward toward the opening 53 of the bait container 51, thereby causing rotation of the release shaft 45 in a counterclockwise direction. This, in turn, rotates the release dog 47 that is secured to shaft 45, thus freeing the trigger gate 49 which holds the detent actuating shaft 35 and detent member 27 in “closed” position. With the detent actuating shaft 35 now unrestrained, the catch mechanism 25 is released, and the closing force of the trap jaws 21 and 23 will cause the detent actuating shaft 35 to push past the trigger gate 49, thereby causing the detent member 27 to rotate freely to its “open” position, as shown in FIGS. 5 and 6. As a direct consequence, the jaws 21 and 23 of the trap 13 are also free to rotate, and will rapidly and forcefully close upon the animal.

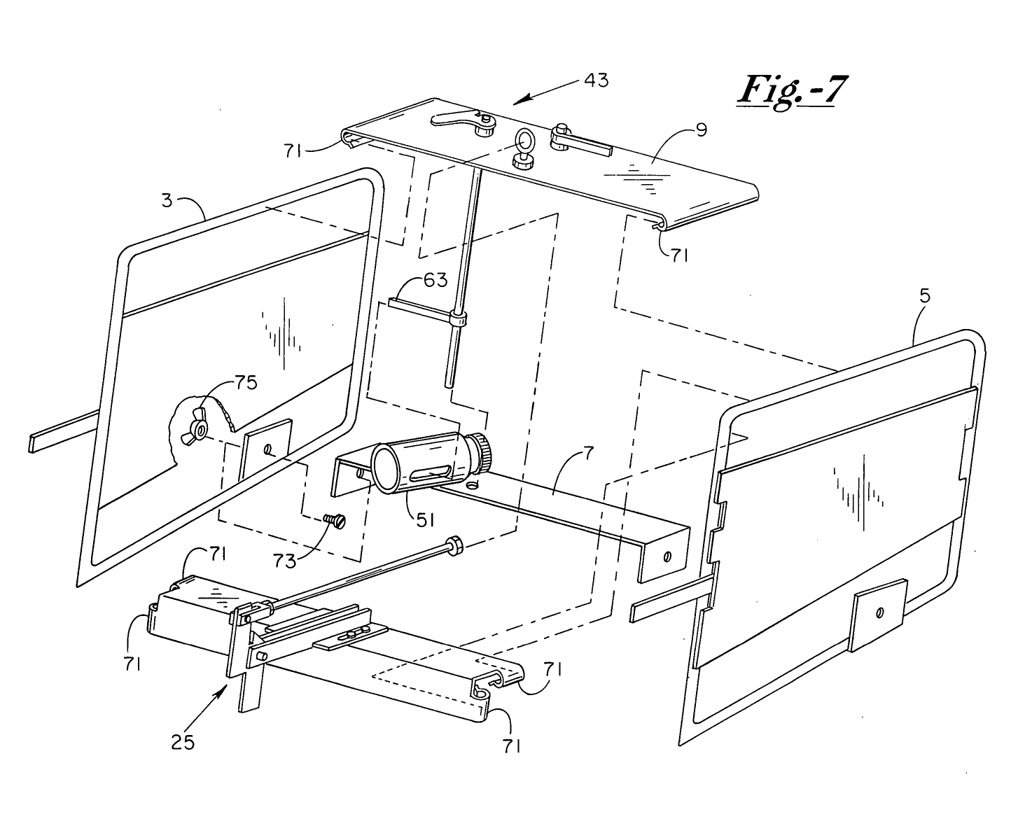

Notably, enclosure 1 of the triggering apparatus is preferably constructed to be collapsible into a plurality of exterior frame sections as a means of convenience to facilitate storage, packaging and transportation thereof. As shown in FIG. 7, enclosure 1 may be broken down into five main components, including (1) side-body frame section 3; (2) side-body frame section 5; (3) the lower cross-panel 7 with attached bait container 51; (4) the forward upper cross-panel 11 with attached catch mechanism 25; and (5) the rear upper cross-panel 9 with attached catch release mechanism 43. Although this collapsible feature may be accomplished by any known means, it is presently contemplated that both of the upper cross-panels 9 and 11 be formed with snap-lock brackets 71 that are designed to snap onto side-body frame sections 3 and 5 for ease of dismantling and securing the same together when desired. The lower cross-panel 7, as shown, may simply be secured on each side to the respective side-body frame section 3 and 5 with a conventional screw 73 and wing nut 75. With such construction, the triggering device may be readily broken down for ease of packaging and shipment, and can be readily transported and reconstructed in the field, when and where desired.

It will, of course, be understood that various changes may be made in the form, details, arrangement and proportions of the parts without departing from the scope of the invention which comprises the matter shown and described herein and set forth in the appended claims.

1. A triggering apparatus for a rotating-frame type animal trap, comprising:
(a) an enclosure defining an interior space and having entrance-defining portions leading to said interior space, said enclosure being constructed to support the animal trap set for actuation adjacent said entrance-defining portions thereof;
(b) a bait container fixedly connected to said enclosure within said interior space thereof, said bait container having opening-defining portions that are of substantially smaller compass than said entrance-defining portions of said enclosure;
(c) a catch mechanism carried by said enclosure and constructed to releasably engage and hold the animal trap in set position on said enclosure prior to actuation thereof; and
(d) a catch release mechanism carried by said enclosure and extending within said bait container, said catch release mechanism being constructed for releasable engagement of said catch mechanism when the trap is supported by said enclosure in its set position, whereby movement of said release mechanism within said bait container will release said catch mechanism and thereby cause actuation of the trap.

2. The triggering apparatus defined in claim 1, wherein said catch release mechanism is comprised of a cantilever having opposite ends, one of said ends being free and extending within said bait container, and the other of said ends being connected to a rotatable release shaft.

3. The triggering apparatus defined in claim 2, including means connected to said release shaft for releasably engaging said catch mechanism, whereby movement of said cantilever within said bait container will cause said release shaft to rotate, thereby releasing said catch mechanism and effecting actuation of the trap.

4. The triggering apparatus defined in claim 1, wherein said means for releasably engaging said catch mechanism includes a release dog that can be variably set for triggering sensitivity.

5. The triggering apparatus defined in claim 1, wherein said catch mechanism includes a detent member that is constructed to engage and hold the trap in its set position, said detent member being pivotally connected to a movable detent actuating shaft that is positioned for releasable engagement by said catch release mechanism.

6. The triggering apparatus defined in claim 5, wherein said detent member is constructed and arranged to hold the trap in set position against said enclosure until released by said catch release mechanism, whereupon axial movement of said dent shaft causes said detent member to pivot to an open position, thereby allowing the trap to actuate.

7. The triggering apparatus defined in claim 1, wherein said enclosure is readily collapsible.

8. The triggering apparatus defined in claim 1, wherein said enclosure is comprised of separable body sections that snap-lock together.

9. The triggering apparatus defined in claim 1, wherein said opening-defining portions of said bait container define an opening having major dimensions of less than approximately 3 inches.

10. The triggering apparatus defined in claim 1, wherein said bait container includes a closeable access disposed generally opposite said opening-defining portions thereof.

11. The triggering apparatus defined in claim 1, wherein said catch release mechanism includes a lever extending within said bait container, said lever being connected to a rotatable release shaft having means connected thereto for releasably engaging said catch mechanism with variable sensitivity when holding a set trap, and wherein said catch mechanism includes a pivotal detent member constructed and arranged to hold the trap in set position against said enclosure until released by said catch release mechanism, whereby movement of said lever within said bait container will cause said release shaft to rotate, thereby releasing said catch mechanism and causing said detent member to pivot to an open position, thereby allowing the trap to actuate.

12. The triggering apparatus defined in claim 1, wherein said catch mechanism is mounted on said enclosure in position-adjustable relation thereto.

13. The triggering apparatus defined in claim 12, wherein said catch mechanism includes a detent member that is outwardly adjustable relative to said enclosure so as to define an adjustable spacing therebetween for receiving the trap.

14. A triggering apparatus in combination with a rotating-frame animal trap, comprising:
(a) an animal trap of the type having similar first and second frames, each frame having sides serving as jaws and ends extending therebetween, said first and second frames being pivotally connected through adjacent ends for relative rotation between set and closed positions about a common axis, and said trap in its said set position defining a passageway through said first and second frames between said adjacent ends and sides thereof.
(b) an enclosure defining an interior space and having entrance-defining portions defining an entrance leading to said interior space, said enclosure being constructed to support said animal trap in said set position adjacent said entrance-defining portions, such that said passageway of said trap is in general alignment with said entrance to said enclosure;
(b) a bait container connected to said enclosure within said interior space thereof, said bait container having opening-defining portions that are of substantially smaller compass than said entrance-defining portions of said enclosure;
(c) a catch mechanism carried by said enclosure and constructed to releasably engage and hold said first and second frames of said animal trap in said set position prior to actuation thereof; and
(d) a catch release mechanism carried by said enclosure and extending within said bait container, said catch release mechanism being constructed for releasable engagement of said catch mechanism when said trap is supported by said enclosure in said set position, whereby movement of said release mechanism within said bait container will release said catch mechanism, causing actuation of said trap and consequent rapid and forceful rotation of said jaws to said closed position.

15. The triggering apparatus defined in claim 14, wherein said catch mechanism includes a pivotal detent member that is constructed to engage and hold the first and second frames of said trap in said set position when supported by said enclosure, said detent member being movably connected to said catch release mechanism and positioned for releasable engagement thereby.

16. The triggering apparatus defined in claim 14, wherein said catch mechanism includes a 15 detent member, and said jaws of said first and second frames of said trap, when supported by said enclosure in said set position, are sandwiched between said enclosure and said detent member and restrained thereby from rotating toward said closed position.

17. The triggering apparatus defined in claim 16, wherein said detent member is movably mounted on said enclosure, and release of said catch mechanism when said trap is supported by said enclosure in said set position allows the rotational force of said first and second frames to freely move said detent out of engagement therewith.

18. The triggering apparatus defined in claim 14, wherein said catch release mechanism includes a lever that extends within said bait container, said lever being connected to a rotatable release shaft that is constructed for releasable engagement of said catch mechanism.

19. The triggering apparatus defined in claim 18, wherein said rotatable release shaft terminates with a variably sensitive release dog that is adapted for releasable engagement of said catch mechanism.

20. The triggering apparatus defined in claim 19, including a movable trigger gate adapted to be releasably held by said release dog and provide a stop to prevent movement and consequent release of said catch mechanism when said trap is supported by said enclosure in said set position.

21. The triggering apparatus defined in claim 14, wherein said enclosure is comprised of readily collapsible body sections that snap-lock together.

22. A triggering apparatus for an animal trap, comprising:
(a) an enclosure defining an interior space and having entrance-defining portions leading to said interior space, said enclosure being constructed to support the animal trap set for actuation adjacent said entrance-defining portions thereof;
(b) a bait container fixedly connected to said enclosure within said interior space thereof, said bait container having opening-defining portions that are of substantially smaller compass than said entrance-defining portions of said enclosure;
(c) a catch mechanism comprising a detent actuating shaft movably mounted on said enclosure with a terminal detent member pivotally connected thereto, said detent member being constructed and arranged to releasably engage and hold the animal trap in set position against said enclosure prior to actuation thereof; and
(d) a catch release mechanism comprised of a release shaft rotatably mounted on said enclosure, and a lever member extending radially outward from said release shaft and into said bait container, said release shaft being connected to a release dog which releasably engages a movable trigger gate that prevents said detent actuating shaft and said detent member from movement when the trap is supported by said enclosure in set position, whereby movement of said lever within said bait container will cause said release shaft and said release dog to rotate, thereby releasing said trigger gate and allowing free movement of said detent member and actuation of the trap.
